(19) United States
(12) Patent Application Publication
(10) Pub. No.: US 2026/0322062 A1
(43) Pub. Date: Oct. 15, 2026

(54) LASER SYSTEM AND METHOD

(71) Applicant: IMPERIAL COLLEGE INNOVATIONS LIMITED, London (GB)

(72) Inventors: Robert MURRAY, London (GB); Ronan BATTLE, London (GB)

(21) Appl. No.: 19/114,993

(22) PCT Filed: Sep. 26, 2022
(86) PCT No.: PCT/EP2022/076683

§ 371 Date: Mar. 25, 2025

(51) Int. Cl. H01S 3/094; G02F 1/35; G02F 1/355

(52) U.S. Cl. CPC H01S 3/094076; G02F 1/3534; G02F 1/3536; G02F 1/3551; H01S 3/094003

(57) ABSTRACT

Laser systems are provided. The laser systems comprise a pump laser source configured to generate pump laser pulses; a first nonlinear medium; and a second nonlinear medium. A cascade of nonlinear processes leads to the generation of optical pulses at different wavelengths. Methods of generating optical pulses are also provided.

### FIELD OF THE INVENTION

The present invention relates to laser systems exploiting nonlinear optical processes, in particular laser systems for producing mid-infrared optical pulses.

### BACKGROUND

Mid-infrared laser sources, that is laser sources operating in the wavelength range stretching from around 2.5 μm to around 25 μm, are of increasing importance in a variety of applications across industry, research, and defence due to both the atmospheric transmission windows and large number of organic molecules that exhibit strong and unique ro-vibrational absorption features in this region.

One such application which is of interest is the use of pulsed laser systems operating at MIR wavelengths for the precise ablation of biological tissue.

The ablation of biological tissue can be exploited in surgical contexts.

The ablation of biological tissue can also be exploited in the technique of high resolution laser mass spectrometry bioimaging, which is described in a review article by K. K. Murray et al. (Methods 104 (2016) 118-126).

In brief, in this technique, laser pulses are focused down to a fine spot size and used to ablate biological tissue. The product of this ablation is directed toward a mass spectrometry instrument, allowing chemical analysis of the site from which the tissue was ablated. By raster scanning the laser spot across the tissue, mass spectrometry can be performed on a ‘pixel by pixel’ basis across the tissue sample, allowing for the capture of rich data on tissue composition at a high resolution within a sample.

Such applications, however, require laser sources operating in the MIR wavelength range, particularly with wavelengths aligned with a water absorption peak around 3 μm or 6 μm. The laser sources also must have suitable pulse parameters (in terms of pulse duration and pulse power) for the purpose of ablation and must have a high beam quality to enable near-diffraction limited focusing.

Generally, it is not possible to obtain optical pulses with suitable properties from the direct output of laser oscillators. Prior art approaches have relied on optical parametric amplifiers (OPA), whereby nonlinear processes are used to convert the output of laser sources from one wavelength to another. Typically, an OPA requires the use of two lasers—a pump laser and a second seed laser, which have to be synchronised in time and carefully overlapped in space in the nonlinear conversion medium. This results in typical MIR OPA systems being complex, unreliable (due to alignment drift) and often suffering from low output beam quality. These deficiencies also prevent the systems being used outside of typical laser laboratory settings, meaning that they cannot be deployed in (for example) clinics, biological research settings and operating theatres.

It is an object of the present invention to provide a pulsed mid-infrared laser source with reduced complexity, better reliability, and more idealised output properties than is possible using systems of the prior art.

### SUMMARY OF THE INVENTION

In a first aspect of the invention, a laser system is provided. The laser system comprises a pump laser source configured to generate pump laser pulses; a first nonlinear medium; and a second nonlinear medium. The laser system is configured such that a pump laser pulse from the pump laser is coupled into the first nonlinear medium to generate a first generated optical pulse, at a different wavelength to the pump laser pulse, through a first nonlinear optical process in the first nonlinear medium. The pump laser pulse and the first generated optical pulse are coupled from the first nonlinear medium into the second nonlinear medium to generate a second generated optical pulse, at a different and longer wavelength to the pump laser pulse and the first generated optical pulse, through a second nonlinear optical process in the second nonlinear medium.

In such a laser system, a cascade of nonlinear processes in the first and second nonlinear media makes it possible to access optical wavelength ranges (for the second generated optical pulse) which are not accessible using a single nonlinear stage. Moreover, the laser pump pulse and the first generated optical pulse, which has been generated in the first nonlinear medium, are used to generate the second generated optical pulse in the second nonlinear medium. Because the first generated optical pulse will be temporally co-located with the pump laser pulse, and travel with it, both the pump laser pulse and the first generated optical pulse will be launched simultaneously into the second nonlinear medium. Hence, this avoids the need to adjust the time delay between the pulses launched into the second nonlinear medium to ensure that they temporally overlap, as is typically the case when mixing optical pulses in a nonlinear medium to generate new optical pulses through nonlinear processes.

In some embodiments, the first nonlinear optical process is four-wave mixing. In particular, the first nonlinear optical process may be spontaneous four-wave mixing.

Advantageously, the use of spontaneous (rather than seeded) four wave mixing allows for the laser system to operate without an additional seed source as a signal to the first nonlinear optical stage which can otherwise introduce additional complexity in terms of launching the seed source into the first nonlinear stage along with the pump laser pulses.

In some embodiments, the first nonlinear medium is an optical fibre, preferably a photonic crystal fibre (PCF).

Advantageously, PCF can be engineered to confine the light to a relatively small core, increasing the intensity of the light within the PCF and enhancing the first nonlinear process. Moreover, the dispersive properties of the PCF can generally be engineered to provide the correct dispersive profile for efficient generation of the first generated optical pulse in the first nonlinear process.

In some embodiments, the dispersive profile of the first nonlinear medium is such that the first nonlinear medium exhibits normal dispersion at the wavelength of the pump laser pulse. In particular, the dispersion in the first nonlinear medium at the wavelength of the pump laser pulse may be less between 0 and −20 ps/(nm·km), preferably the dispersion in the first nonlinear medium at the wavelength of the pump laser pulse may be between 0 and −10 ps/(nm·km).

Advantageously, pumping in the low normal dispersion region suppresses optical effects such as soliton self-frequency shift and supercontinuum generation which might otherwise deplete the optical power at the wavelength of the first generated optical pulse.

In some embodiments, the dispersive profile of the first nonlinear medium is such that the walk off length between the first generated optical pulse and the pump laser pulse is greater than the optical path length through the first nonlinear medium. Preferably the walk-off length may be at least two times the optical path length, and most preferably wherein the walk-off length may be at least five times the optical path length.

Advantageously, with the walk-off length being longer than the optical path length, it can be ensured that there is minimal walk off between the pump laser pulse and the first generated optical pulse as they propagate through the first nonlinear medium. This, in turn, helps ensure the first generated optical pulse is temporally overlapped with the pump laser pulse at the exit of the first nonlinear stage, which will in turn maximise the overlap of those pulses in the second nonlinear stage, enhancing the efficiency of the second nonlinear process and the generation of the second generated optical pulse.

In some embodiments, the second nonlinear optical process is three-wave mixing. In particular, the second nonlinear optical process may be difference-frequency generation.

Advantageously, difference-frequency generation in the second nonlinear medium can be used to access longer wavelength ranges than can be accessed through the first nonlinear process alone. Moreover, because the wavelength of the second generated optical pulse will be dictated by the difference between the optical frequency of the pump laser pulse and the optical frequency of the first generated optical pulse, the wavelength of the second generated optical pulse can be determined by the design of the pump laser and the first nonlinear stage.

In some embodiments, the difference in optical frequency between the pump laser pulse and the first generated optical pulse is greater than 40 THz, and preferably may be greater than 80 THz.

Configuring the laser system to have such a difference in optical frequency between the pump laser pulse and the first generated optical pulse can allow the second generated optical pulse to be generated at optical wavelengths with utility in certain applications.

In some embodiments, the wavelength of the first generated optical pulse corresponds to a signal wavelength in the second nonlinear optical process, the wavelength of the second generated optical pulse corresponds to an idler wavelength in the second nonlinear optical process, and the wavelength of the pump laser pulse corresponds to a pump wavelength in the second nonlinear optical process.

That is to say, the wavelength of the first generated optical pulse, generated in the first nonlinear process, can be engineered such that it acts as a signal in the second nonlinear process. When pumped by the pump laser pulse wavelength this will ultimately result in a second generated optical pulse which is generated at a particular target idler wavelength, thereby allowing the laser system to access a predetermined longer wavelength than could be achieved using a single nonlinear stage.

In some embodiments, the second nonlinear medium is a nonlinear crystal. Preferably it may be a periodically poled nonlinear crystal, and more preferably it may be a periodically poled lithium niobate crystal.

Use of a periodically poled nonlinear crystal is particularly advantageous as it can permit quasi-phase matching to target a particular wavelength or wavelength range for the second generated optical pulse.

In some embodiments, the laser system further comprises a means for controlling the temperature of the nonlinear crystal, preferably wherein the means for controlling the temperature of the nonlinear crystal is a crystal oven in which the nonlinear crystal is held.

By controlling the temperature of the nonlinear crystal, the phase matching of the second nonlinear optical process can be controlled so as to target a particular wavelength for the second generated optical pulse.

In some embodiments, the system is configured such that the peak wavelength of the second generated optical pulse is tunable across a range of peak idler wavelengths by adjusting the temperature of the nonlinear crystal using the means for controlling the temperature of the nonlinear crystal.

Advantageously, this allows the peak wavelength of the second generated optical pulse to be tuned across a range of wavelengths, which is useful in certain applications.

In some embodiments, the temperature of the crystal determines phase matching between the wavelength of the pump laser pulse and the second generated laser pulse, and the optical spectrum of the first generated laser pulse is sufficiently broad to provide a phase-matched signal across the range of peak idler wavelengths. The laser system may be configured such that the range of peak idler wavelengths exceeds 20 nm. Preferably the range of peak idler wavelengths may exceed 50 nm, and more preferably the range of peak idler wavelengths May exceed 100 nm.

Advantageously, where the optical spectrum of the first generated laser pulse is broad, compared to the phase matching acceptance bandwidth of the nonlinear crystal in the second nonlinear stage, tuning the peak wavelength of the second generated optical pulse can be effected solely by tuning the temperature of the crystal in the second nonlinear stage without needing to adjust the pump laser or the first nonlinear stage.

In some embodiments, the second generated optical pulse has a peak wavelength in the mid infrared range, preferably wherein the second generated optical pulse has a peak wavelength in the range of 2.7-3.2 μm.

This wavelength range is, advantageously, well suited to various biomedical and spectroscopic applications as it corresponds to a peak absorption wavelength in water (associated with the OH bond). For example, the second generated laser pulses emitted from the laser system can be used to rapidly heat tissues to effect ablation of biological tissue. As a further example, the laser system can be used in optical spectroscopic applications.

In some embodiments, the first generated optical pulse has a peak wavelength in the range of 1.5 to 1.8 μm.

In some embodiments, the first nonlinear process is vectorial four wave mixing, wherein the pump laser pulse is coupled into a first polarization axis of the first nonlinear medium and the first generated optical pulse is generated on a second polarization axis of the first nonlinear medium.

Advantageously, this means that the laser pump pulse and first generated optical pulse will be temporally and spatially co-located but also will inherently be polarised across orthogonal axes without the need to control the polarisation of one of the pulses relative to the other.

In some embodiments, the second nonlinear optical process is colinear type-I phase matched three-wave mixing, preferably wherein the three-wave mixing is difference frequency generation.

In general, such phase matching requires the polarisation of the pump field to be orthogonal to the polarisation of the signal and idler fields. By using such a nonlinear crystal in combination with vectorial four-wave mixing in the first nonlinear stage, the pump laser pulse and the first generated optical pulse will be inherently phase matched for the second nonlinear optical process in the second nonlinear medium, allowing for efficient generation of the second generated optical pulse through the second nonlinear optical process.

In some embodiments, the second nonlinear medium is a nonlinear crystal, preferably the second nonlinear medium may be a cadmium silicon diphosphide crystal.

Advantageously, cadmium silicon diphosphide (CdSiP₂, which might also be referred to as cadmium silicon phosphide or ‘CSP’) provides a nonlinear optical material with a high nonlinear coefficient, has a high thermal conductivity, and is well suited to the generation of optical pulses across a range of infrared wavelengths which can be useful in a variety of applications.

In some embodiments, the first generated optical pulse has a peak wavelength in the range of 1.2-1.3 μm. Furthermore, the second generated optical pulse may have a peak wavelength in the range of 4 μm to 8 μm. It preferably may be in the range of 5 μm to 7 μm, and more preferably may be in the range of 6 μm to 6.5 μm.

This wavelength range is, advantageously, well suited to various biomedical and spectroscopic applications as it corresponds to a peak absorption wavelength in water (associated with the H—O—H bend in the water molecule). For example, the second generated laser pulses emitted from the laser system can be used to rapidly heat tissues to effect ablation of biological tissue. As a further example, the laser system can be used in optical spectroscopic applications.

In some embodiments, the second generated optical pulse may have a pulse duration in the range of 5-2000 picoseconds, preferably it may be in the range of 20-1000 picoseconds, most preferably it may be in the range of 20-150 picoseconds.

Implementing a system with pulse durations on the order of tens to hundreds of picoseconds has been found to be advantageous for certain applications. On the one hand, the pulses are long enough such that tissue can be ablated without the formation of plasma, an effect associated with femtosecond and few picosecond duration optical pulses, which results in dangerous free radicals which can affect neighbouring cells, and/or (importantly for mass spectrometric analysis) alter the chemical and biological profile of the ablated tissue plume. On the other hand, the pulses are short enough to confine the ablation to the relatively small area to which the laser is focused, when compared to the use of optical pulses of many nanoseconds up to microseconds which might cause damage to a surrounding tissue area and/or cause material to be ablated and ejected from a large area of a biological sample.

In some embodiments, the pump laser pulse has a peak wavelength in the near infrared range. The pump laser pulse may preferably have a peak wavelength around 1 μm.

Many laser sources are available which operate around the near infrared range, and in particular around the 1 μm (i.e. within the range of 1.0 to 1.1 μm), which offer long term stable operation and good energy efficiency. By implementing the cascade of nonlinear process of the present invention it is possible to realise the advantages of such laser systems but still providing an output of laser pulses in a wavelength range which would otherwise not be possible to access.

In some embodiments, the pump laser pulse has a pulse duration in the range of 5 to 3000 picoseconds. Preferably it may be in the range of 20 to 1500 picoseconds, and most preferably it may be in the range of 30 to 225 picoseconds.

Advantageously, by providing laser pump pulses with the specified durations, the first generated optical pulse and the second generated optical pulse will be generated with pulse durations of a similar order duration. This way, advantageously, it is possible to provide second generated optical pulses of an appropriate duration for certain applications without needing to temporally stretch or compress optical pulses at the output of the second nonlinear stage, or between the first and second nonlinear stages. That is to say, by tailoring the pulse duration of the pump laser pulse, the inherent temporal overlap in the generated optical pulses through the cascade with the pump laser pulses will result in the second generated laser pulses being generated with an appropriate duration.

In some embodiments, the pump laser source is an ytterbium doped fibre laser source and may comprise an ytterbium doped fibre mode-locked oscillator and/or one or more ytterbium doped fibre amplifiers.

Ytterbium doped fibre laser systems, generally, offer advantages such as being compact, energy efficient and reliable. Moreover, in embodiments where an optical fibre is used as the first nonlinear medium, the use of an ytterbium doped fibre laser system means that it may be possible to fibre integrate the first nonlinear medium with the pump laser system, further reducing the footprint of the laser system and improving its reliability.

In some embodiments, the pump laser source comprises a semiconductor laser and in other embodiments the pump laser source comprises a microchip laser.

Semiconductor lasers or microchip lasers can be used which generate pulses on the order of hundreds of picoseconds, well suited to certain applications of the present invention.

In some embodiments, the pump laser source comprises a pulse stretcher.

Advantageously, using a pulse stretcher as part of the pump laser source can allow the use of laser oscillators which provide desirable (e.g.) thermal or power characteristics, whilst still achieving a pulse duration for the pump laser pulses which will give rise to efficient conversion of the optical energy through the cascade of nonlinear optical media.

In some embodiments, the laser system further comprises an optical modulator between the pump laser source and the first nonlinear medium.

Advantageously, this allows the pulse repetition rate of the laser system to be varied, or individual pulses picked, with the properties of the second generated optical pulse remaining constant.

In a second aspect of the invention, a laser system is provided. The laser system comprises a pump laser source configured to generate pump laser pulses; a first nonlinear medium; and a second nonlinear medium. The laser system is configured such that a pump laser pulse from the pump laser is coupled into the first nonlinear medium to generate a first generated optical pulse, at a different wavelength to the pump laser pulse, through a first nonlinear optical process in the first nonlinear medium, wherein the first nonlinear process is vectorial four wave mixing, wherein the pump laser pulse is coupled into a first polarization axis of the first nonlinear medium and the first generated optical pulse is generated on a second polarization axis of the first nonlinear medium, and the pump laser pulse and the first generated optical pulse are coupled from the first nonlinear medium into the second nonlinear medium to generate a second generated optical pulse, at a different wavelength to the pump laser pulse and the first generated optical pulse, through a second nonlinear optical process in the second nonlinear medium.

As with the first aspect of the invention, in such a laser system, a cascade of nonlinear processes in the first and second nonlinear media makes it possible to access optical wavelength ranges (for the second generated optical pulse) which are not accessible using a single nonlinear stage. Moreover, the laser pump pulse and the first generated optical pulse, which has been generated in the first nonlinear medium, are used to generate the second generated optical pulse in the second nonlinear medium. Because the first generated optical pulse will be temporally co-located with the pump laser pulse, and travel with it, both the pump laser pulse and the first generated optical pulse will be launched simultaneously into the second nonlinear medium without the need to adjust the time delay between the pulses launched into the second nonlinear medium to ensure that they temporally overlap, as is typically the case when mixing optical pulses in a nonlinear medium to generate new optical pulses through nonlinear processes. Moreover, the use of vectorial four wave mixing in the first nonlinear medium, results in the laser pump pulse and first generated optical pulse not only being temporally and spatially co-located, but also being inherently polarised across orthogonal axes without the need to control the polarisation of one of the pulses relative to the other.

In a third aspect of the invention, a method of generating optical pulses is provided. The method comprises generating a pump laser pulse using a pump laser source; coupling the pump laser pulse into a first nonlinear medium; generating a first generated optical pulse, at a different wavelength to the pump laser pulse, through a first nonlinear optical process in the first nonlinear medium; coupling the pump laser pulse and the first generated optical pulse from the first nonlinear medium into a second nonlinear medium; generating a second generated optical pulse, at a different wavelength to the pump laser pulse and the first generated optical pulse, through a second nonlinear optical process in the second nonlinear medium. The second generated laser pulse is at a longer wavelength to the pump laser pulse and the first generated optical pulse.

In a fourth aspect of the invention, a method of generating optical pulses is provided. The method comprises generating a pump laser pulse using a pump laser source; coupling the pump laser pulse into a first polarization axis of a first nonlinear medium; generating a first generated optical pulse, at a different wavelength to the pump laser pulse and on a second polarization axis of the first nonlinear medium, through vectorial four wave mixing in the first nonlinear medium; coupling the pump laser pulse and the first generated optical pulse from the first nonlinear medium into a second nonlinear medium; generating a second generated optical pulse, at a different wavelength to the pump laser pulse and the first generated optical pulse, through a second nonlinear optical process in the second nonlinear medium.

### LIST OF FIGURES

FIG. 1 depicts a laser system of the present invention.

FIG. 2 depicts a laser system in accordance with an embodiment of the present invention.

FIG. 3a is a graph of the dispersion profile of a photonic crystal fibre used in the laser system of FIG. 2.

FIG. 3b is a graph of the phase matching curve for four wave mixing based on the dispersion profile of FIG. 3a.

FIG. 4a is a graph of the temperature dependent phase matching curve for a nonlinear crystal used in the laser system of FIG. 2.

FIG. 4b is a graph of the phase matching curve for a nonlinear crystal used in the laser system of FIG. 2.

FIG. 5a is a graph showing the optical spectrum of the output from the first nonlinear stage in the laser system of FIG. 2.

FIG. 5b is a graph showing the optical spectrum of the output from the laser system of FIG. 2.

FIG. 6 is a graph showing the optical spectrum of the output from the laser system of FIG. 2 for a range of nonlinear crystal temperatures.

FIG. 7 depicts a laser system in accordance with another embodiment of the present invention.

### DETAILED DESCRIPTION

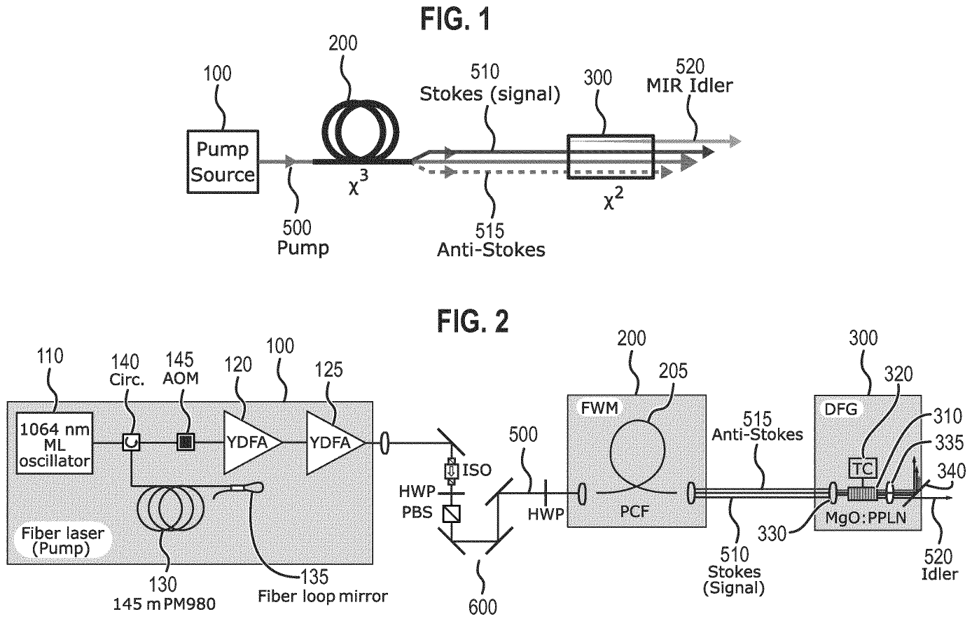

FIG. 1 illustrates a laser system of the present invention.

At a high level, the laser system comprises a pump laser source 100, a first nonlinear medium 200 and a second nonlinear medium 300. In the system of FIG. 1, the first nonlinear medium takes the form of optical fibre 200 and the second nonlinear medium takes the form of nonlinear crystal 300. It will be appreciated that other nonlinear media may be used in place of one or other of the optical fibre 200 and optical crystal 300, depending on the specific circumstances.

The pump laser source output 500 consists of a train of optical pulses, i.e. pump laser pulses. The output 500 from the pump laser source 100 is coupled into the optical fibre 200. In the optical fibre, the pump laser pulse will interact with the optical fibre 200 and, through a first nonlinear optical process, a first generated optical pulse will be generated.

In the system illustrated in FIG. 1, the first nonlinear optical process is four wave mixing in the optical fibre 200, in particular pump-degenerate spontaneous four wave mixing.

In general, four wave mixing is a nonlinear effect which arises from third-order term nonlinearity in the material (i.e. dominated by the χ⁽³⁾ coefficient of the material in which an optical field propagates). Assuming two input optical frequency components propagate in a nonlinear medium (such as optical fibre 200), this gives rise to the generation of two additional frequency components. The sum of the optical frequency of the two new frequency components will equal the sum of the optical frequency of the two input optical frequency components. In the case of pump-degenerate four wave mixing, the two input optical frequency components are at the same optical frequency. In the case illustrated in FIG. 1, the optical field of the pump laser pulse provides amplification for two new frequency components, equally spaced in frequency around the pump optical frequency. The new component with a higher optical frequency (i.e. having a shorter wavelength) is generally referred to as the ‘Anti-Stokes’ component. The new component with a lower optical frequency (i.e. having a longer wavelength) is generally referred to as the ‘Stokes’ component.

Four-wave mixing is a phase sensitive process, that is to say, the interaction depends on the relative phases of the input components and the generated components. The effect can therefore only efficiently accumulate if a phase matching condition is satisfied. In an optical fibre, the chromatic dispersion of the optical fibre can be engineered to provide effective phase matching between the wavelength of the pump laser component and particular, targeted, wavelengths for the newly generated optical components.

It will, of course, be appreciated that the four wave mixing process can be enhanced by coupling in an optical component at either the Stokes or anti-Stokes wavelength, that component being amplified by the four wave mixing process and this also enhances the generation of the other respective component. However, this requires the additional complexity of coupling a further laser source into the PCF, and moreover requires temporally synchronising the launched component at the Stokes or anti-Stokes wavelength with the pump optical pulse to ensure effective nonlinear interaction. For this reason, the use of spontaneous four wave mixing in the first stage (rather than seeded four wave mixing) is preferred because it reduces system complexity and also because the spontaneously generated Stokes and anti-Stokes pulses will be inherently synchronous with the pump laser pulses.

Because not all of the pump laser pulse will be converted into the Stokes and anti-Stokes components, the output from the optical fibre 200 will consist of undepleted pump, along with the Stokes component 510 and anti-Stokes component 515. In effect, part of the optical energy of each pump laser pulse will be converted to a co-propagating optical pulse at the Stokes wavelength (i.e. a Stokes pulse), and another co-propagating optical pulse at the anti-Stokes wavelength (i.e. an anti-Stokes pulse).

In the laser system of FIG. 1, the Stokes pulse provides the first generated optical pulse. Because the Stokes pulse is generated through a nonlinear optical process it will inherently overlap in time and space with the first generated optical pulse.

It will be appreciated that, whilst the invention has been described with particular reference to four wave mixing in optical fibre 200, the first nonlinear optical process might be a different nonlinear optical process known in the art, and the first nonlinear medium might be a different type of nonlinear medium known in the art. The skilled person will appreciate that selection of the nonlinear medium, and configuring the system to exploit a particular nonlinear optical process will allow them to configure the system to generate a first generated optical pulse at a particular target wavelength for the first generated optical pulse.

Returning to FIG. 1, the residual pump laser pulse and the Stokes pulse are coupled into the nonlinear crystal 300 where a second nonlinear process will take place to provide a second generated optical pulse. In particular, the pump laser pulse and the Stokes pulse interact in the nonlinear crystal 300 through the nonlinear optical process of difference frequency generation.

In general terms, difference frequency generation is a nonlinear optical process which arises from second-order term nonlinearity in the material (i.e. it is dominated by the χ⁽²⁾ term of the material in which the optical field propagates). In this process, two input beams interact to generate another beam with an optical frequency which is the difference of the optical frequencies of the input beams. Difference frequency generation is an example of so-called ‘three wave mixing’ processes, in which three beams interact (typically two input beams and an output beam). Other examples of three wave mixing include sum frequency generation, optical parametric amplification and second harmonic generation.

In the case of FIG. 1, coupling the pump laser pulse and the Stokes laser pulse into the nonlinear crystal 300 will result in amplification of the Stokes (signal) pulse, but importantly the generation of an idler component 520 through the process of difference frequency generation. The idler component will consist of idler pulses which are the second generated optical pulses, where the Stokes laser pulse is at a corresponding signal wavelength to the idler wavelength of the difference frequency generation process. The idler pulse will be generated with an optical frequency equal to the difference in frequency between the pump laser pulse and the Stokes signal pulse.

Thus, the optical frequency (or equivalently, the wavelength) of the idler pulse will be determined by the wavelength of the pump laser pulses and the wavelength at which the Stokes pulse is generated in the first nonlinear medium. The wavelength of the pump laser pulse is dictated by the properties of the pump laser source. The wavelength of the Stokes pulse is dictated by the phase matching of the nonlinear process in the optical fibre 200, which can be controlled by appropriate engineering of the chromatic dispersion of the optical fibre 200.

The cascade of nonlinear processes described above can advantageously allow the generation of optical pulses at a longer wavelength than can be achieved in a single nonlinear stage.

Certain examples of this architecture will be described below.

### First Example: Accessing the 3 μm Wavelength Range Using a PCF and a PPLN Crystal

In a first example, cascaded nonlinearities of spontaneous four wave mixing in a photonic crystal fibre (PCF) and quasi-phase matched difference frequency generation in a periodically poled lithium niobate crystal (PPLN) are used to generate mid infrared (MIR) pulses at around 3 μm.

A schematic of the laser system used in this example is shown in FIG. 2.

The pump laser source 100 in this case comprises an ytterbium fibre master oscillator power amplifier (MOPA) system. In particular, the pump laser source 100 comprises a 50 MHz mode-locked ytterbium fibre oscillator 110 that produces optical pulses with 5 picosecond duration and a wavelength of 1064 nm. The pulses are coupled, via an optical circulator 140 to double pass a length of polarization maintaining fibre 130, reflected by fibre loop mirror 135. The circulator 140, fibre 130 and fibre loop mirror 135 provide a pulse stretcher, which stretches the pulse duration from 5 ps duration to 35 ps.

It has been found that the efficiency of frequency conversion at each stage of the nonlinear cascade is sensitive to the peak power of the pump laser pulse, which in turn is dependent upon its duration. This is compounded by there being two nonlinear stages and so the overall efficiency of the system is sensitive to the pump laser pulse duration. In this regard, a pulse stretcher may be beneficial because the pump laser pulse duration can be tailored to enhance the overall efficiency of the frequency conversion across the two stages.

The next component in the optical chain of the pump laser system 100 is a pulse picker 145, in this case in the form of an acousto-optic modulator (AOM), which can be used to select pulses from the train of pump pulses and thereby reduce the effective repetition rate. For example, the repetition rate may be reduced to a few MHz. Of course, if higher repetition rates are desired then the AOM might be omitted.

In another embodiment, a fibre integrated semiconductor laser might be used in place of a mode-locked ytterbium fibre oscillator. Semiconductor lasers can be operated to provide pulses in the picosecond to few nanosecond range. In particular, a semiconductor laser could be used which provides pulses with a duration between 100 ps and 2000 ps, preferably with a duration in the range of few hundreds of ps (i.e. 100 to 400 ps). In this situation, the pulse stretcher might be omitted. Moreover, because semiconductor lasers might be operated at lower repetition rates than a mode locked laser, it might also be possible to omit the AOM.

In a further embodiment, a microchip laser might be used in place of a mode-locked ytterbium fibre oscillator. Such laser systems can be operated to provide pulses with a duration in the range of few hundreds of ps (i.e. 100 to 400 ps). Such lasers can be operated at lower repetition rates or can even be controlled to provide a ‘single shot’ pulse. The pulse energies from such lasers tend to be higher than mode-locked ytterbium fibre oscillators or pulsed semiconductor laser systems, making it easier to reach high pulse energies for the pump laser pulses after amplification and, consequently, making it easier to reach high pulse energies for the second generated optical pulse (i.e. the MIR idler pulse). The pump laser pulses are then amplified in and optical amplifier chain consisting of a first ytterbium-doped fibre amplifier (YDFA) 120 and a second YDFA 125. Alternatively, a single amplifier might provide sufficient power amplification, or a greater number of amplifiers might be included in the amplifier chain.

After amplification, the pump laser pulses are output from the pump laser system 100.

In the system of FIG. 2, a series of free space optics 600 is used to couple the output of the pump laser system into the PCF 205 which provides the first nonlinear medium 200.

In particular, the output is collimated by a lens and relayed via a series of mirrors through a free space optical isolator (ISO), a half wave-plate (HWP) and polarizing beam splitter (PBS). In this case, adjusting the HWP can be used to adjust the amount of pump laser power which will pass through the PBS and thereafter be coupled into the PCF. A second HWP is used to align the polarization of the pump beam to the polarisation axis of the PCF 205, and a second lens is used to couple light into a face of the PCF 205.

It will of course be appreciated that the free space optics 600 used to couple the pump laser pulses into the PCF 205 may take many different forms. For example, a simple series of lenses may be used to couple the pump laser pulses into the input face of the PCF 200. Moreover, it will be appreciated that the output of the pump laser source 100 might be fibre-integrated with the PCF 205, omitting the requirement for any free space optics 600 to couple pump laser pulses into the first nonlinear medium 200.

Optionally, in some embodiments, a modulator can be included between the output of the optical amplifier chain and the input of the PCF. For example, the collimated output of the pump laser system can be directed through a bulk acousto-optic modulator (AOM). This can be used to pick the pump pulses from single shot up to the repetition rate of the pump laser, whilst maintaining peak power (and energy) in each pulse. This is advantageous in many applications. For example, in mass spectrometric imaging (discussed above), it is desirable to deliver pulses synchronously with the scan rates of the mass spectrometer, which may be on the order of tens of Hz. Triggering the AOM to provide pulses at a desired point in time is desirable (e.g., in this example the scan rate of the mass spectrometer). The pulse peak power (or equivalently, pulse energy) at the output of the pump laser will be constant, despite any change in repetition rate from use of the AOM to pick certain pulses. As a result, the non-linear processes in the PCF and nonlinear crystal (which will be inherently dependent upon the peak power of the pulses) will remain constant. This in turn ensures that the pulse properties of the MIR pulses will remain constant, whilst the pulse repetition rate can be varied, or individual pulses picked, using the AOM.

This is advantageous compared to using an AOM at the output of the nonlinear stages (for example), because the nonlinear stages will be subject to less overall power and their lifetime will be improved. On the other hand, it is advantageous compared to relying on an AOM before the amplifier chain, because the pulse repetition rate can affect the degree of amplification within the amplifier chain, meaning that the pulse peak power output from the amplifier chain (and, ultimately, the properties of the generated MIR pulses) might vary as the pulse repetition rate is altered.

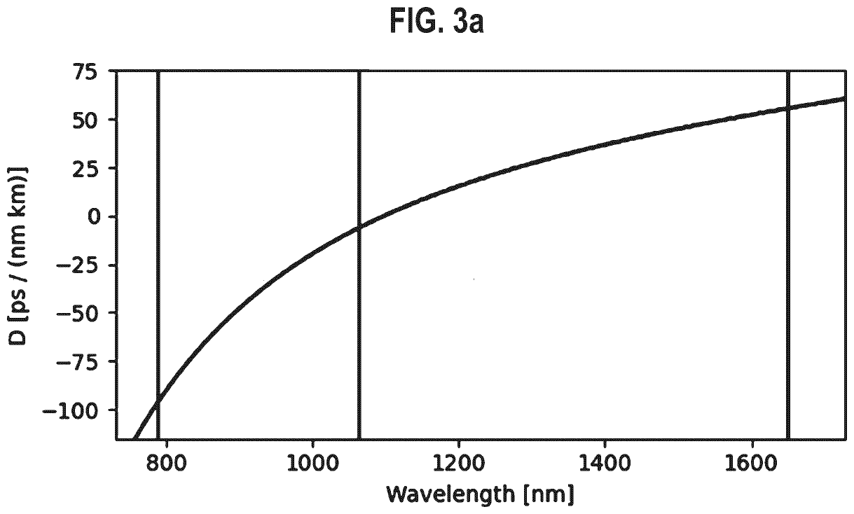

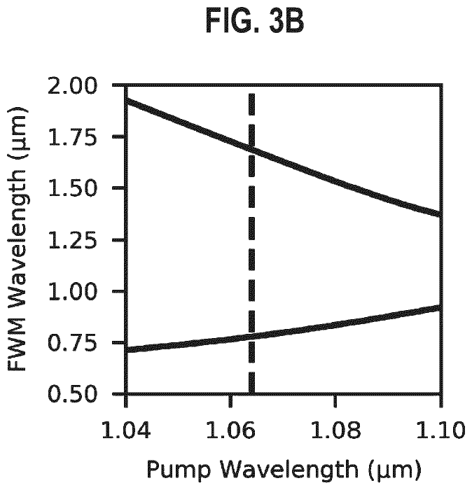

The dispersion profile of the PCF is shown in FIG. 3a. Here, the dispersion profile is expressed in terms of the dispersion parameter, D, which can be defined by:

$${D}_{λ} = - \frac{λ}{c} \cdot \frac{{δ}^{2} n}{{δλ}^{2}}$$

where λ is the wavelength, c is the speed of light in a vacuum, and n is the wavelength-dependent refractive index of the medium.

As can be seen, at the pump wavelength of 1.064 μm, the PCF exhibits normal dispersion (i.e. the dispersion parameter D is negative) and is low, at −6 ps/(nm km).

The calculated phase matching profile for the four-wave mixing process in the PCF is shown in FIG. 3b. As can be seen, a pump wavelength of 1.064 μm (i.e. the pump laser wavelength) is phase matched to a Stokes component around 1.65 μm and an anti-Stokes component around 0.785 μm. Hence, the Stokes component (i.e. first generated optical pulse) will be generated at a wavelength of 1.65 μm. Strictly speaking, as will be appreciated, the phase-matching condition has a non-linear term which is a function of the pump peak power. In FIG. 3b, a pump peak power of 10 KW is assumed, but a different pump peak power would not substantially impact the phase matching mechanism.

Returning to FIG. 2, the output from the PCF 205 (comprising the residual pump 500, the Stokes component 510 and the anti-Stokes component 515) is collimated with a lens and directed toward the second nonlinear medium 300.

Using a lens 330, the output from the PCF 205 is coupled into a periodically poled lithium niobate (PPLN) crystal 310.

As is known in the art, periodically poled nonlinear crystal materials provide quasi-phase matching of nonlinear interactions within the nonlinear crystal. Such crystals have a periodic reversal of the domain orientation in the nonlinear crystal so that the sign of the nonlinear coefficient changes periodically along the length of the crystal. The periodic distance over which the domain orientation is reversed is referred to as the ‘polling period’. This polling period determines the phase matching within the crystal. Because of thermal expansion, the length of the polling period will change slightly depending on the crystal temperature. Hence, the precise phase matching within a periodically poled crystal will depend on its temperature.

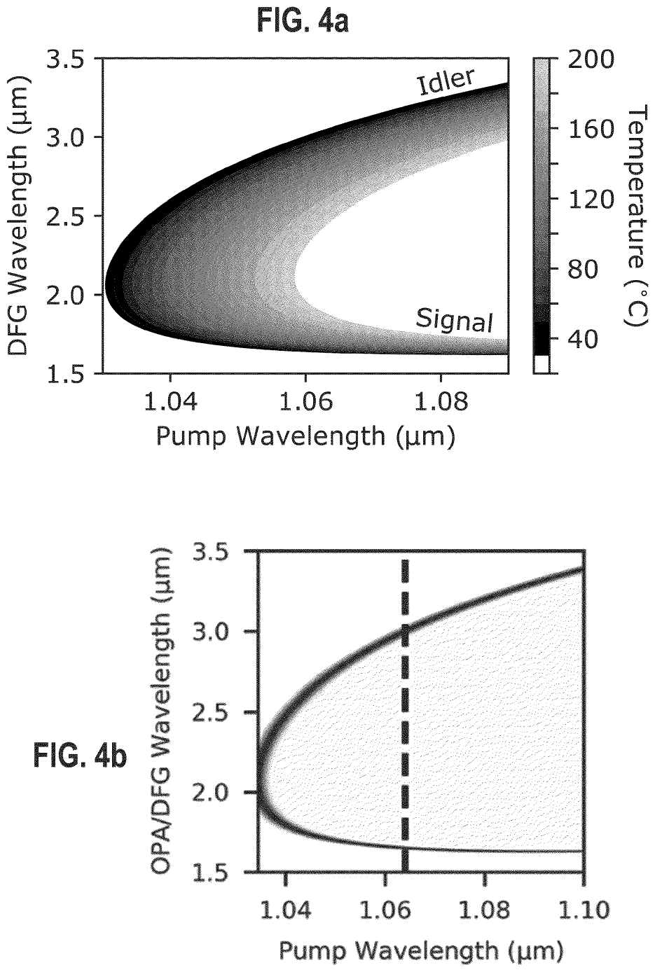

To this end, the PPLN crystal 310 is held within a crystal oven (not shown) which is controlled by a temperature controller 320. This enables the temperature of the crystal to be controlled. The temperature-dependent phase matching curve for the PPLN crystal is shown in FIG. 4a, with an exemplary plot of the phase matching curve shown in FIG. 4b for a crystal temperature of 60° C. As can be seen, a pump wavelength of 1.064 μm (i.e. the wavelength of the pump laser pulse) is phase matched to a signal wavelength of 1.65 μm (i.e. the wavelength of the first generated laser pulse, generated in the first nonlinear medium), and a MIR idler wavelength around 3.0 μm. This means that energy from the pump laser component will amplify the Stokes signal component at 1.65 μm which will in turn result in the generation of a new component at the MIR idler wavelength. It will be appreciated that synchronously coupling in the pump pulse and a signal pulse will lead to amplification of the signal pulse, and the generation and amplification of the idler pulse. Thus, the efficiency of the transfer of energy from the pump component to the signal and idler components is vastly improved compared to a situation where only the pump component is coupled into the PPLN crystal 210.

Hence, coupling the pump laser pulse along with the first generated optical pulse (i.e. the Stokes pulse) from the output of the PCF 205 into the PPLN crystal 310 will result in generating a second generated optical pulse at the MIR idler wavelength, thereby having a wavelength around 2.9 μm.

The output from the PPLN crystal 310 is recollimated using lens 335 and passed through a long-pass dichroic filter 340 which filters out the shorter wavelength components (i.e. the laser pump components, and the Stokes and anti-Stokes components from the first nonlinear stage), leaving only the MIR idler component 520.

It will be appreciated that other nonlinear crystals can be used in place of PPLN, including other periodically poled and patterned nonlinear crystals for temperature controlled quasi phase matching, such as Orientation Patterned Gallium Phosphide (OP-GaP) or Orientation Patterned Gallium Arsenide (OP-GaAs), for example.

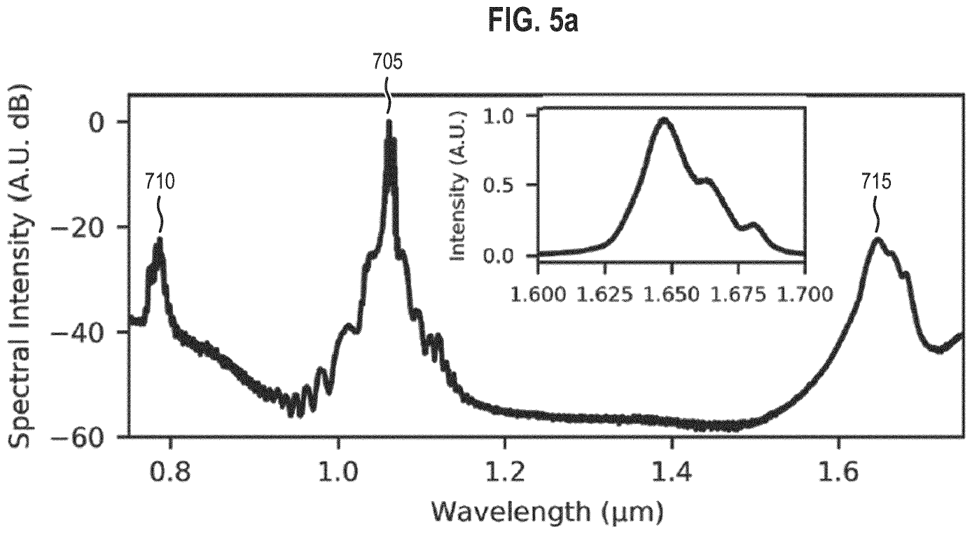

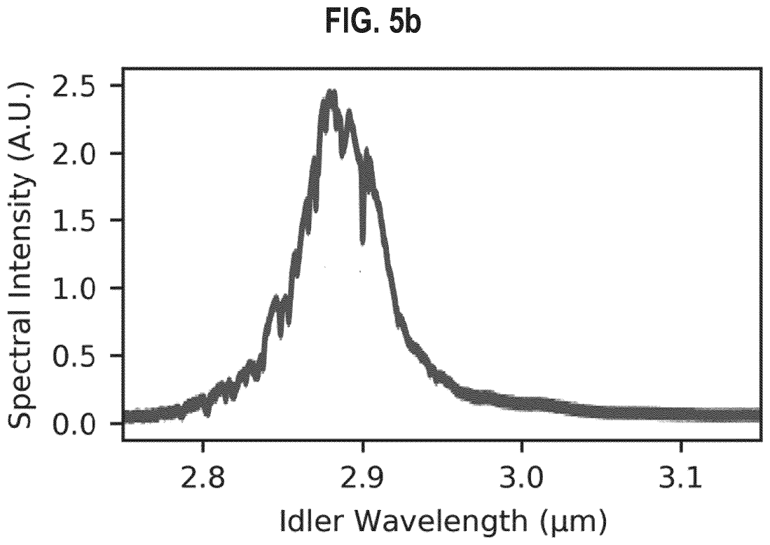

Results from the system are shown in FIG. 5. FIG. 5a shows the optical spectrum at the output from the PCF 205. In this spectrum there is a peak 705 around 1.064 μm corresponding to undepleted pump laser output 500. There is also a peak 710 around 0.785 μm corresponding to the Anti-Stokes component 515 generated through four wave mixing in the PCF 205. There is also a peak 715 around 1.65 μm corresponding to the Stokes component 510 generated through four wave mixing in the PCF 205. Detail of peak 715 is shown in the inset to the graph in FIG. 5a on a linear scale.

FIG. 5b shows the optical spectrum at the output from the second nonlinear stage after filtering using the long-pass dichroic filter at a crystal temperature of 100° C. This illustrates that a strong spectral component around 2.9 μm has been generated. It was found that over 100 mW of optical power could be produced, at a repetition rate of 8 MHz (yielding a pulse energy of over 12.5 nJ).

It will be appreciated that the frequency conversion in the second nonlinear medium 300 will be limited by the so-called acceptance bandwidth of the medium. In practical systems, phase matching of nonlinear processes will not occur at single defined wavelengths but over a finite wavelength range. Hence, for efficient nonlinear conversion in difference frequency generation in the second nonlinear medium, a substantial amount of the optical power of the Stokes signal (i.e. first generated) optical pulse must fall within the phase-matched acceptance bandwidth for effective generation of the MIR idler (i.e. second generated optical pulse).

As will be appreciated from FIG. 5a, the optical spectrum around the 1.65 μm peak at the output of the PCF 205 is relatively broad. This can be attributed in part to the use of spontaneous (rather than seeded) four-wave mixing in the first nonlinear stage, as there will be some wavelength range across which effective phase matching is achieved in the PCF.

The relatively broad spectrum does not, however, prevent effective difference frequency generation in the PPLN crystal 310. This is because it has been found that the acceptance bandwidth is generally relatively broad in the case of nonlinear processes which convert optical power to longer wavelength components (when compared to three wave mixing processes for converting to shorter wavelengths, such as sum frequency generation or second harmonic generation). It has therefore been found that MIR pulses can effectively be generated at appreciable optical powers even with a relatively broad spectrum for the Stokes signal pulse. Hence, it is possible to generate appreciable power in the MIR range whilst achieving the advantages associated with spontaneous four wave mixing (discussed above).

The system of FIG. 2 also allows for control of the wavelength of the second generated output pulses through control of the temperature of the PPLN crystal 310 using temperature controller 320.

This can be appreciated with reference to FIG. 4a, which shows the temperature dependent phase matching. Despite the pump optical wavelength remaining constant at 1.064 μm, it is still possible to phase match across a broad range of MIR wavelengths, depending on the temperature of the crystal. The efficiency of the conversion to the MIR idler wavelengths will of course be contingent on there being appreciable optical signal at the corresponding signal wavelength from the Stokes signal pulse (generated in the first nonlinear stage). This is provided in the present laser system—because of spontaneous four wave mixing in the first nonlinear stage, the spectrum of the Stokes signal component is sufficiently broad to provide a phase-matched signal across a range of phase matched wavelengths to which the PPLN crystal 310 can be tuned by altering its temperature using the temperature control 320 to control the temperature of the oven in which the crystal 310 is held.

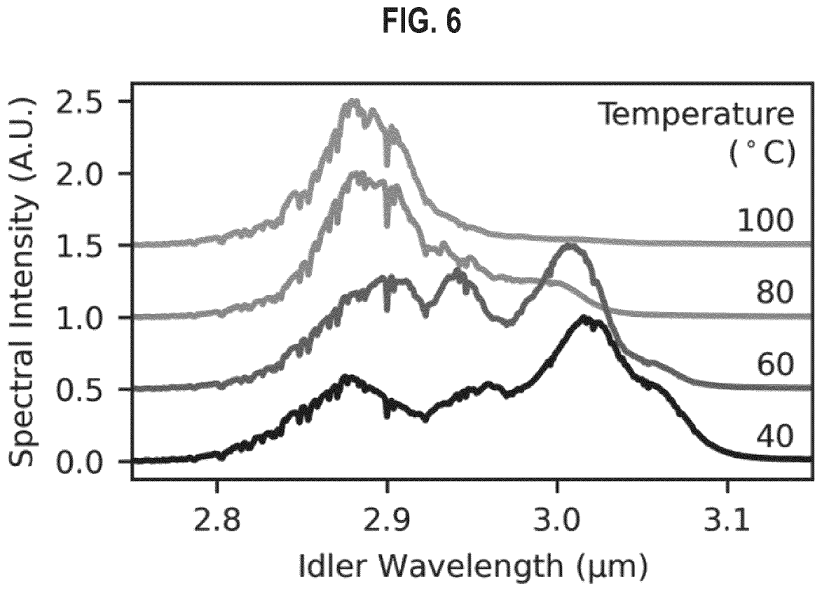

Results from tuning the temperature on the spectrum of the MIR idler component (i.e. the second generated optical pulse) are shown in FIG. 6. As can be seen, the peak wavelength of the MIR idler can be tuned across a range in excess of 200 nm, with a peak wavelength of less than 2.9 μm for a crystal temperature of 100° C. and a peak wavelength in excess of 3.0 μm for a crystal temperature of 40° C.

### Second Example: Accessing the 5-6 μm Wavelength Range Using Vectorial Four Wave Mixing in a Birefringent Fibre and Type-I Phase Matched DFG in a CSP Crystal

In a second example, cascaded nonlinearities of spontaneous vectorial four wave mixing in a birefringent PCF and type-I phase matched difference frequency generation in a cadmium silicon diphosphide (CSP) crystal are used to generate MIR pulses at around 6 μm.

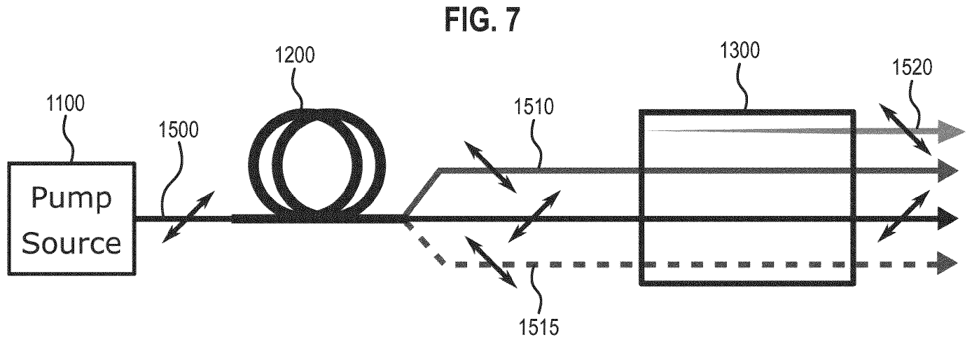

The second example system is set out schematically in FIG. 7. This system is similar in many respects to the system of the first example, shown in FIG. 2, and to the general schematic shown in FIG. 1.

As with the first example, the laser system comprises a pump laser source 1100, a first nonlinear medium in the form of a PCF 1200 and a second nonlinear medium in the form of a nonlinear crystal 1300.

In this example, the PCF 1200 is a birefringent PCF, and is configured with chromatic dispersion profiles across its two axes of polarisation to provide phase matching for a vectorial four wave mixing process.

Vectorial four wave mixing is a specific case of four wave mixing. A description of four wave mixing in general is given above, and will not be repeated here. In vectorial four wave mixing, specifically, the nonlinear interaction leads to the generation of optical waves with a different polarisation to the input optical waves, and generally requires a birefringent medium to provide phase matching between different frequency components across different respective polarisation axes. This can be achieved (as in the present example) by using a birefringent PCF, which exhibits different dispersive properties on different polarisation axes. The dispersive profile of such a fibre can be engineered such that wavelengths on one polarisation axis are phase matched to wavelengths on an orthogonal polarisation axis. In particular, for vectorial four wave mixing, the dispersive properties on the different polarisation axes are such that the pump wave is phase matched to Stokes and anti-Stokes waves on an orthogonal polarisation to the pump wave.

Returning to FIG. 7, the pump laser source 1100 is configured to provide a pump beam 1500 with a particular polarisation, denoted by the double-headed arrow. This is coupled into the birefringent PCF 1200. It will be appreciated that the system may comprise a means of adjusting the polarisation of the pump laser beam 1500 to align with the appropriate polarisation axis of the fibre 1200. This may take the form of a half waveplate or the like. It will also be appreciated that the output of the pump laser source might be unpolarised, but a polarising element (such as a polarising beam splitter or the like) used to select a particular polarisation component for coupling into the PCF. As for the pump laser source 1100 itself, it may be substantially the same as the pump laser source 100 of the first example.

Each pump laser pulse propagates through the PCF and will generate an anti-Stokes component 1515 and a Stokes component 1510. As with the first example, the anti-Stokes component 1510 provides the first generated optical pulse. Because these new components have been generated through vectorial four wave mixing, they have an orthogonal polarisation to the pump laser pulses, as indicated by the double headed arrows.

As with the first example, because not all of the pump laser pulse will be converted into the Stokes and anti-Stokes components, the output from the optical fibre 1200 will consist of undepleted pump, along with the Stokes component 1510 and anti-Stokes component 1515. In effect, part of the optical energy of each pump laser pulse will be converted to a co-propagating optical pulse at the Stokes wavelength (i.e. a Stokes pulse), and another co-propagating optical pulse at the anti-Stokes wavelength (i.e. an anti-Stokes pulse).

As noted above, in this laser system, the Stokes pulse provides the first generated optical pulse. Because the Stokes pulse is generated through a nonlinear optical process it will inherently overlap in time and space with the first generated optical pulse.

Significantly, because the Stokes pulse is generated through vectorial four wave mixing, it will inherently be generated with an orthogonal polarisation to the pump laser pulse. It is preferred in this example that spontaneous vectorial four wave mixing is used (rather than a seeded process) for the same reasons as explained for the first example, above.

Returning to FIG. 7, the residual pump laser pulse and the Stokes pulse are coupled into the nonlinear crystal 1300 where a second nonlinear process will take place to provide a second generated optical pulse. In particular, the pump laser pulse and the Stokes pulse interact in the nonlinear crystal 1300 through the nonlinear optical process of difference frequency generation. In contrast to the first example above, however, phase matching in the nonlinear crystal need not be achieved through periodic polling to achieve quasi phase matching.

Instead, the second nonlinear optical process is colinear type-I phase matched difference frequency generation. In the laser system of FIG. 7, the inherent birefringence in the nonlinear crystal provides phase matching between different optical components in a nonlinear optical process. In type-I phase matching, the pump and signal waves have orthogonal polarisations, and the idler wave is generated with a polarisation which matches the signal wave.

Typically, to exploit this form of phase matching it would be necessary to carefully control the relative polarisations of the various optical beams input into the nonlinear crystal. However, as explained above, by exploiting vectorial four wave mixing in the first nonlinear stage, the pump laser component 1500 and Stokes (signal) component 1510 will inherently be orthogonally polarised with respect to each other, and so can exploit type-I phase matching in the nonlinear crystal without the need to adjust the polarisation of one beam with respect to the other (for example).

It will be appreciated that the inherent orthogonal polarisation between the laser component 1500 and Stokes (signal) component could be exploited with a type-II phase matched nonlinear crystal, in which the pump and signal components are orthogonal, but in which the idler component is generated with a polarisation which matches the pump wave. The type of phase matching employed in the nonlinear crystal will depend on the birefringent properties of the crystal which determine the phase matching conditions for a given nonlinear process.

In the example of the system of FIG. 7, the nonlinear crystal 1300 is a cadmium silicon diphosphide crystal and type-I phase matching is used.

In particular, in the laser system of FIG. 7, the dispersion profile of the birefringent PCF 1200 is controlled to provide phase matching between the 1.064 μm and a Stokes component around 1.26 μm.

With this separation in frequency between the pump laser beam 1500 and the Stokes component 1510, in the nonlinear crystal 1300 an idler component will be generated at 6 μm.

This wavelength range is of particular interest because it corresponds to a peak absorption wavelength in water (associated with the H—O—H bend in the water molecule). For example, the second generated laser pulses emitted from the laser system can be used to rapidly heat tissues to effect ablation of biological tissue. As a further example, the laser system can be used in optical spectroscopic applications.

It will be appreciated that other wavelength ranges can be targeted for other applications by suitable engineering of the dispersive properties of the birefringent fibre to effect phase matching to a suitably separated Stokes component. Moreover, other nonlinear crystals can be used to generate the MIR idler, for example Zinc Germanium Phosphide (ZGP, ZnGeP2), and these could be used in place of CSP.

It will be understood that the embodiments described above are exemplary and the invention is defined by the appended claims.

1-7. (canceled)

8. A laser system comprising:
a pump laser source configured to generate pump laser pulses;
a first nonlinear medium; and
a second nonlinear medium,
wherein the laser system is configured such that
a pump laser pulse from the pump laser is coupled into the first nonlinear medium to generate a first generated optical pulse, at a different wavelength to the pump laser pulse, through a first nonlinear optical process in the first nonlinear medium,
the pump laser pulse and the first generated optical pulse are coupled from the first nonlinear medium into the second nonlinear medium to generate a second generated optical pulse, at a different and longer wavelength to the pump laser pulse and the first generated optical pulse, through a second nonlinear optical process in the second nonlinear medium.

9. The laser system of claim 8, wherein the first nonlinear optical process is spontaneous four-wave mixing.

10. (canceled)

11. The laser system of claim 8, wherein the first generated optical pulse is at a longer wavelength to the pump laser pulse.

12. The laser system of claim 8, wherein the first nonlinear medium is an optical fibre, preferably a photonic crystal fibre.

13. The laser system of claim 8, wherein the second nonlinear optical process is three-wave mixing, and wherein the second nonlinear optical process is difference-frequency generation.

14. (canceled)

15. The laser system of claim 8, wherein the second nonlinear medium is at least one of a nonlinear crystal, a periodically poled nonlinear crystal, or a periodically poled lithium niobate crystal.

16. The laser system of claim 15, further comprising a means for controlling a temperature of the nonlinear crystal, wherein the means for controlling the temperature of the nonlinear crystal is a crystal oven in which the nonlinear crystal is held, and wherein the system is configured such that a peak wavelength of the second generated optical pulse is tunable across a range of peak idler wavelengths by adjusting the temperature of the nonlinear crystal using the means for controlling the temperature of the nonlinear crystal.

17. (canceled)

18. The laser system of claim 16, wherein the temperature of the crystal determines phase matching between the wavelength of the pump laser pulse and the second generated laser pulse, and wherein the optical spectrum of the first generated laser pulse is sufficiently broad to provide a phase-matched signal across the range of peak idler wavelengths, wherein the range of peak idler wavelengths exceeds 20 nm.

19. (canceled)

20. The laser system of claim 8, wherein the second generated optical pulse has a peak wavelength in the mid infrared range, wherein the second generated optical pulse has a peak wavelength in the range of 2.7-3.2 μm, and/or wherein the first generated optical pulse has a peak wavelength in the range of 1.5-1.8 μm.

21. (canceled)

22. The laser system of claim 8, wherein:
the wavelength of the first generated optical pulse corresponds to a signal wavelength in the second nonlinear optical process,
the wavelength of the second generated optical pulse corresponds to an idler wavelength in the second nonlinear optical process,
and the wavelength of the pump laser pulse corresponds to a pump wavelength in the second nonlinear optical process.

23. The laser system of claim 8, wherein the dispersive profile of the first nonlinear medium is such that the first nonlinear medium exhibits normal dispersion at the wavelength of the pump laser pulse, and wherein the dispersion in the first nonlinear medium at the wavelength of the pump laser pulse is between 0 and −20 ps/(nm km).

24. (canceled)

25. The laser system of claim 8, wherein the dispersive profile of the first nonlinear medium is such that the walk off length between the first generated optical pulse and the pump laser pulse is greater than the optical path length through the first nonlinear medium.

26. The laser system of claim 8, wherein the difference in optical frequency between the pump laser pulse and the first generated optical pulse is greater than 40 THz.

27. The laser system of claim 8, wherein the second generated optical pulse has a pulse duration in the range of 5-2000 picoseconds.

28. (canceled)

29. The laser system of claim 8, wherein the pump laser pulse has a pulse duration in the range of 5 to 3000 picoseconds, and wherein the pump laser source comprises one or more of:
an ytterbium doped fibre laser source;
an ytterbium doped fibre mode-locked oscillator;
one more ytterbium doped fibre amplifiers;
a semiconductor laser; and
a microchip laser.

30-33. (canceled)

34. The laser system of claim 8, comprising an optical modulator between the pump laser source and the first nonlinear medium, and wherein the pump laser source comprises a pulse stretcher.

35-45. (canceled)

46. A laser system comprising:
a pump laser source configured to generate pump laser pulses;
a first nonlinear medium; and
a second nonlinear medium,
wherein the laser system is configured such that
a pump laser pulse from the pump laser is coupled into the first nonlinear medium to generate a first generated optical pulse, at a different wavelength to the pump laser pulse, through a first nonlinear optical process in the first nonlinear medium, wherein the first nonlinear process is vectorial four wave mixing, wherein the pump laser pulse is coupled into a first polarization axis of the first nonlinear medium and the first generated optical pulse is generated on a second polarization axis of the first nonlinear medium, and
the pump laser pulse and the first generated optical pulse are coupled from the first nonlinear medium into the second nonlinear medium to generate a second generated optical pulse, at a different wavelength to the pump laser pulse and the first generated optical pulse, through a second nonlinear optical process in the second nonlinear medium.

47. The laser system of claim 46, wherein the second nonlinear optical process is colinear type-I phase matched three-wave mixing, wherein the three-wave mixing is difference frequency generation;
wherein the second nonlinear medium is a cadmium silicon diphosphide crystal; and
wherein the first nonlinear medium is a birefringent photonic crystal fibre.

48. The laser system of claim 46, wherein the first generated optical pulse has a peak wavelength in the range of 1.2-1.3 μm, and wherein the second generated optical pulse has a peak wavelength in the range of 4 μm to 8 μm.

49. A method of generating optical pulses, the method comprising:
generating a pump laser pulse using a pump laser source;
coupling the pump laser pulse into a first nonlinear medium;
generating a first generated optical pulse, at a different wavelength to the pump laser pulse, through a first nonlinear optical process in the first nonlinear medium;
coupling the pump laser pulse and the first generated optical pulse from the first nonlinear medium into a second nonlinear medium;
generating a second generated optical pulse, at a different wavelength to the pump laser pulse and the first generated optical pulse, through a second nonlinear optical process in the second nonlinear medium,
wherein the second generated laser pulse is at a longer wavelength to the pump laser pulse and the first generated optical pulse.
